(19) United States
(12) Patent Application Publication
(10) Pub. No.: US 2010/0224744 A1
(43) Pub. Date: Sep. 9, 2010

(54) Universal Portable Device Stand and Holder Apparatus

(75) Inventors: Santo R. Curatolo, Palm Beach Gardens, FL (US); Giorgio Curatolo, East Setauket, NY (US)

Correspondence Address: THE LAW OFFICES OF ANTHONY L. MEOLA, 2500 WESTCHESTER AVENUE, SUITE 401, PURCHASE, NY, 10577, US

(73) Assignee: C & C Designs Technology, LLC

(21) Appl. No.: 12/400,371

(22) Filed: Mar. 9, 2009

(51) Int. Cl. F16M 11/04; A44B 18/00

(52) U.S. Cl. 248/176.3; 24/442

(57) ABSTRACT

An apparatus that securely supports and displays for adjustable viewing of portable electronic devices where the apparatus can be frictionally engaged into any accessible material seam as well as being supportable on flat surfaces.

### CROSS REFERENCE TO RELATED APPLICATIONS

The present application relates to and takes priority from co-pending U.S. Provisional Application Serial No. 60/034,997, filed on Mar. 9, 2008 and entitled “A UNIVERSAL PORTABLE DEVICE STAND AND HOLDER APPARATUS”, which application is hereby incorporated by reference its entirety.

### BACKGROUND OF THE INVENTION

1. Field of the Present Invention

The present invention relates generally to an apparatus that securely holds, supports and displays for adjustable viewing of portable electronic devices where the apparatus can be frictionally engaged into any accessible material seam as well as being supportable on flat surfaces.

2. Description of the Related Art

There are several prior art devices in the field. U.S. Pat. No. 6,888,940 discloses a device with magnetic holder having a cup formed of a ferromagnetic material. The rear surface of the cup includes a double-sided adhesive pad to provide attachment of the cup to a vehicle dashboard surface. An obvious drawback to this design is the lack of portability. Once affixed to the dashboard the device cannot be moved to another location. In addition, the adhesive will likely tarnish the finish on dashboard lowering the value the car substantially lower. Another drawback exists in that the device is not easily adjustable preventing suitable viewing of the portable electronic device engaged thereto.

There exists a need to create a device that is removable attached to support the electronic device to prop up for better hands free viewing. Such a device will likely focus on the traveler which likely requires a portable holder movable from vehicle to vehicle.

Additionally, there exists a need for a device with an interchangeable cap for multiple applications and electronic devices.

There also exists a need for a device that maintains a portable electronic device in a car in a suitable viewing position without interfering with the withheld viewing area of a driver. There also exists a need for a device to hold portable devices in an upright fixed position while driving within arms length of driver.

### SUMMARY OF THE INVENTION

The present invention includes a universal portable device stand and holder apparatus.

In a first aspect, the present invention includes an elongated base portion having a wedge end and a pivot end; a mounting portion, the mounting portion rotationally and pivotally connected to the base portion at the pivot end, the mounting portion for releasably engaging the portable device; the mounting portion including a mounting cap structured and arranged to releasably engage the portable device; and the base portion having at least one ridge located substantially proximal to the wedge end and being substantially parallel to the pivot end, the at least one ridge including an elevated forward facing surface and an elevated rearward facing surface for frictionally engaging an orifice of a support structure in order to support the device and an engaged portable device in a desired position.

In some embodiments the apparatus includes a snap and fit connection, the snap and fit connection for connecting the mounting portion to the pivot end of the base portion.

In some embodiments the apparatus includes a pin connection, the pin connection for connecting the mounting portion to the pivot end of the base portion.

In some embodiments the base portion includes a tapered shape such that the pivot end has a larger width than the wedge end.

In some embodiments the base portion includes a wedge shape such that the pivot end has a large depth than the wedge end.

In some embodiments the mounting portion including a magnetic portion for engaging the portable device.

In some embodiments the mounting portion including a hook and loop combination for engaging the portable device.

### BRIEF DESCRIPTION OF THE DRAWINGS

While the specification concludes with claims particularly pointing out and distinctly claiming the present invention, it is believed the same will be better understood from the following description taken in conjunction with the accompanying drawings, which illustrate, in a non-limiting fashion, the best mode presently contemplated for carrying out the present invention, and in which like reference numerals designate like parts throughout the Figures, wherein:

FIG. 1 shows a forward view of the apparatus according to one embodiment of the present invention;

FIG. 2 shows a disassembled view of the apparatus as shown in FIG. 1;

FIG. 3 shows an expanded view of the apparatus as shown in FIG. 2;

FIG. 4A shows rotated view of the apparatus as shown in FIG. 2;

FIG. 4B shows a rotated view of the apparatus as shown in FIG. 1 with the mounting portion rotated;

FIG. 5 shows a rotated view of the apparatus as shown in FIG. 4a with the mounting portion rotated completely;

FIG. 6 shows the apparatus as shown in FIG. 1 engaged with a portable electronic device disposed on a flat surface;

FIG. 7 shows the apparatus as shown in FIG. 1 engaged with a portable electronic device disposed in a wedged vehicle seam position;

FIG. 8 shows the apparatus as shown in FIG. 7 from a front perspective;

FIG. 9A shows another view of the apparatus as shown in FIG. 6;

FIG. 9B shows another view of the apparatus as shown in FIG. 9 in a rotated position;

FIG. 10 shows an expanded perspective view of the apparatus disassembled;

FIG. 11 shows another view of the apparatus assembled as shown in FIG. 10;

FIG. 12 shows a perspective view of another apparatus according to a second embodiment of the present invention;

FIG. 13 shows a side view of the apparatus as shown in FIG. 12;

FIG. 14 shows a rotated exploded view of the apparatus 10 disassembled as shown in FIG. 12;

FIG. 15 shows a side view of the apparatus assembled as shown in FIG. 14;

FIG. 16 shows a rotated exploded view of apparatus 10 disassembled as shown in FIG. 12;

FIG. 17 shows an opposite side view of the apparatus as shown in FIG. 12 with the mounting portion rotated;

FIGS. 18A and 18B show a side view and a top view respectively of apparatus 10 as shown in FIG. 12 with the mounting portion rotated completely;

FIGS. 19A-19L show various exploded and assembled views of the apparatus 10 according to one embodiment of the present invention;

FIG. 20 shows an enlarged view of the mounting portion 5 according to one embodiment of the present invention;

FIGS. 21A and 21B show a side view of mounting portion 5 without exemplary sizes and dimensions;

FIGS. 22A and 22B show a disassembled and assembled view of apparatus 10 according to one embodiment of the present invention; and

FIG. 23A shows an enlarged view of the base portion 1 with exemplary sizes and dimensions; and

FIGS. 24A and 24B shows enlarged and perspective views of apparatus 10 in the assembling process.

### DETAILED DESCRIPTION OF THE PREFERRED EMBODIMENTS

The present disclosure will now be described more fully with reference to the Figures in which an embodiment of the present disclosure is shown. The subject matter of this disclosure may, however, be embodied in many different forms and should not be construed as being limited to the embodiments set forth herein.

The apparatus includes base portion with ridges that can be frictionally engaged into any crevice or seam in car's interior as well as seam in a airplane seat tray table configuration. Where there is a crevice created between the tray and the seat back when the tray is in its upright and locked position. The base portion may be wedged into the tray table seat back crevice into a cantilevered position to hold a portable electronic device in place in front of a passenger for easy viewing. The apparatus does not leave a footprint on the dash board or any other surface.

The apparatus wedges into a seam in the dash board and is removable and usable in other cars or other locations that have a location to receive the base portion wedge end and frictionally engage the ridges to support the holder and a portable electronic device. Due to the high tension pivot mechanism, the holder is usable on many applications including on a flat surface.

The use of magnetic is useful for some apparatuses that include a magnetic pad secured thereon and can be magnetically fixed to the mounting portion. The apparatus is small, portable and usable in many applications and location.

Parts list:

1—base portion

2—Cantilevered beam portions

3—notch position

4—Retention loops

5—interchangeable cap/top mounting portion

6—friction engaging ridges

8—pivot pin aperture

9—pivot pin

10—entire apparatus

14—interchangeable cap interface

15—magnetic fitting

16—rotational cap

17—cap ridges

27—alternate base portion friction ridges

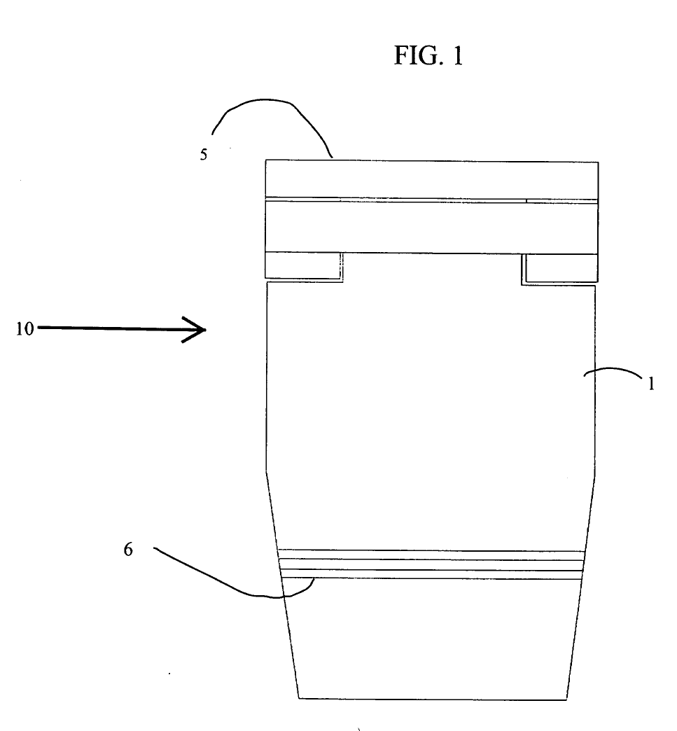

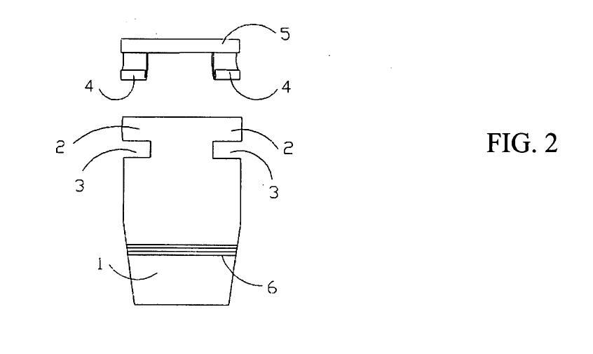

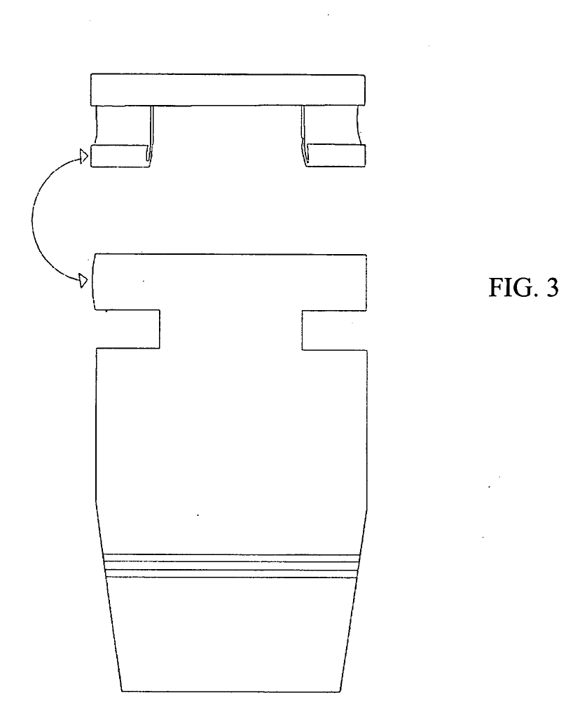

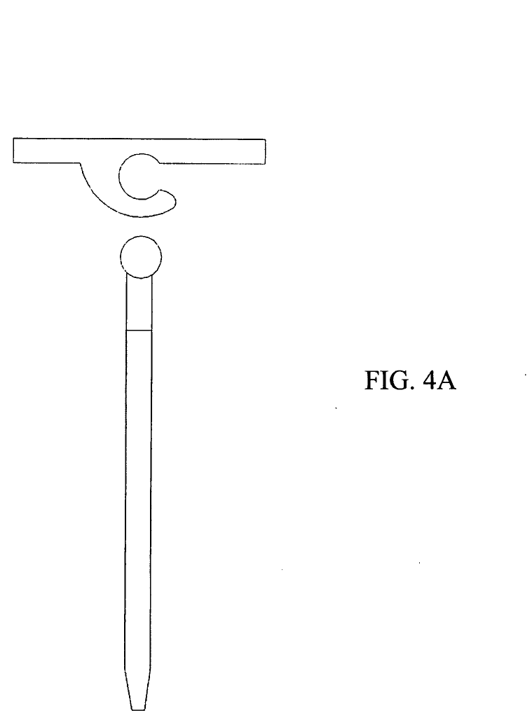

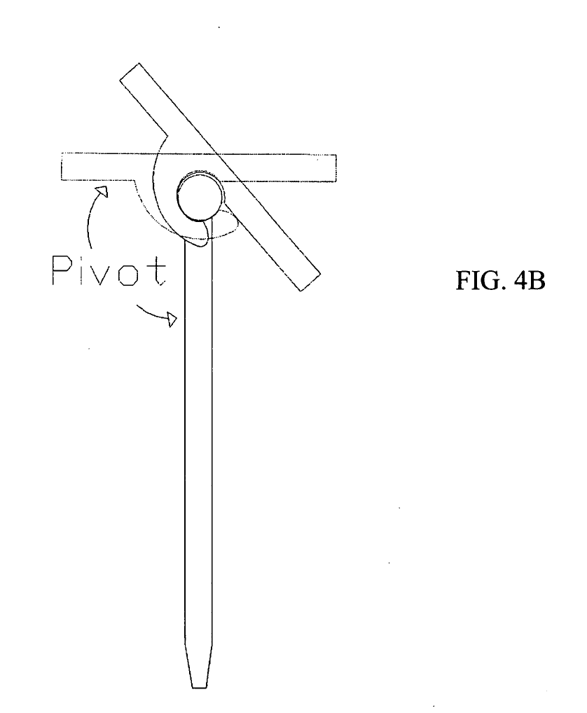

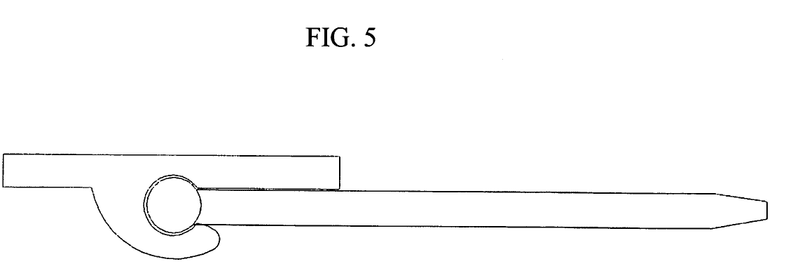

Referring now to FIG. 1 there is shown a forward view of apparatus 10 according to one embodiment of the present. Apparatus 10 includes base portion 1 having friction engaging ridges 6 and is rotationally connected to interchangeable cap/top mounting portion 5. FIG. 2 shows and exploded view of apparatus 10 as shown in FIG. 1. Mounting portion 5 includes retention loops 4 which are structured and arranged to connect to base portion 1 by mating with cantilevered beam portions 2 as shown in FIG. 3. Retention loops 4 have an open face and removably connect to base portion 1 via apertures 3 allowing mounting portion 5 to rotate axially and perpendicular to base portion 1. In some embodiments the releasable connection between retention loops 4 and cantilevered beam portions 2 is preferably a snap-fit type connection. FIGS. 4A, 4B, and 5 show side view of apparatus 10 with mounting portion 5 removed, connected and fully rotated in conjunction with base portion 1.

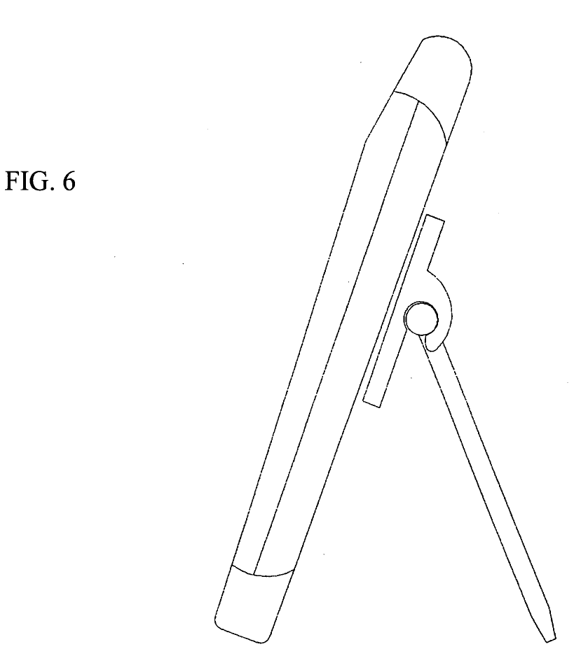

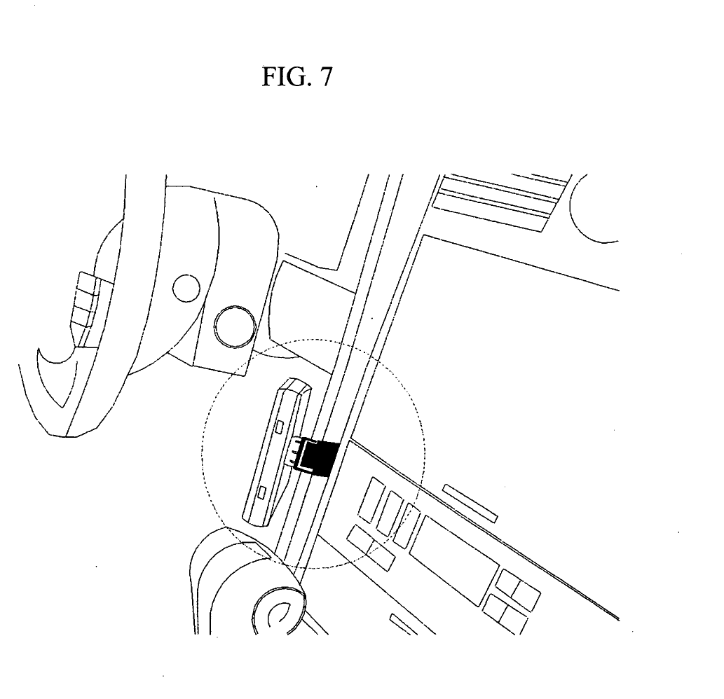

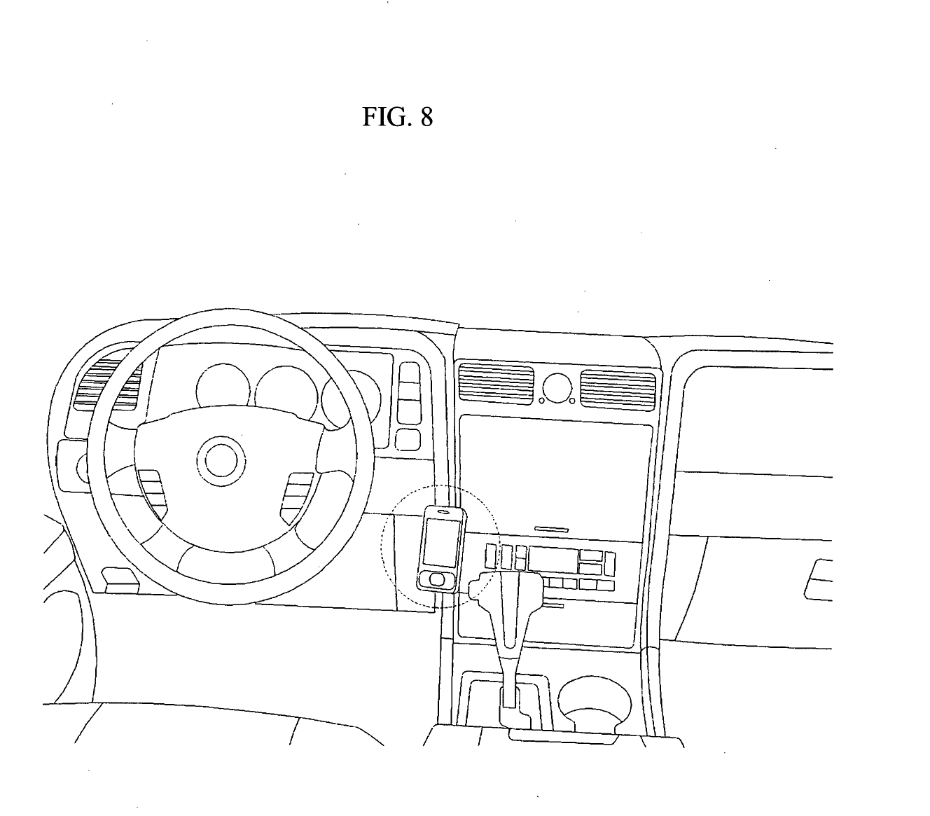

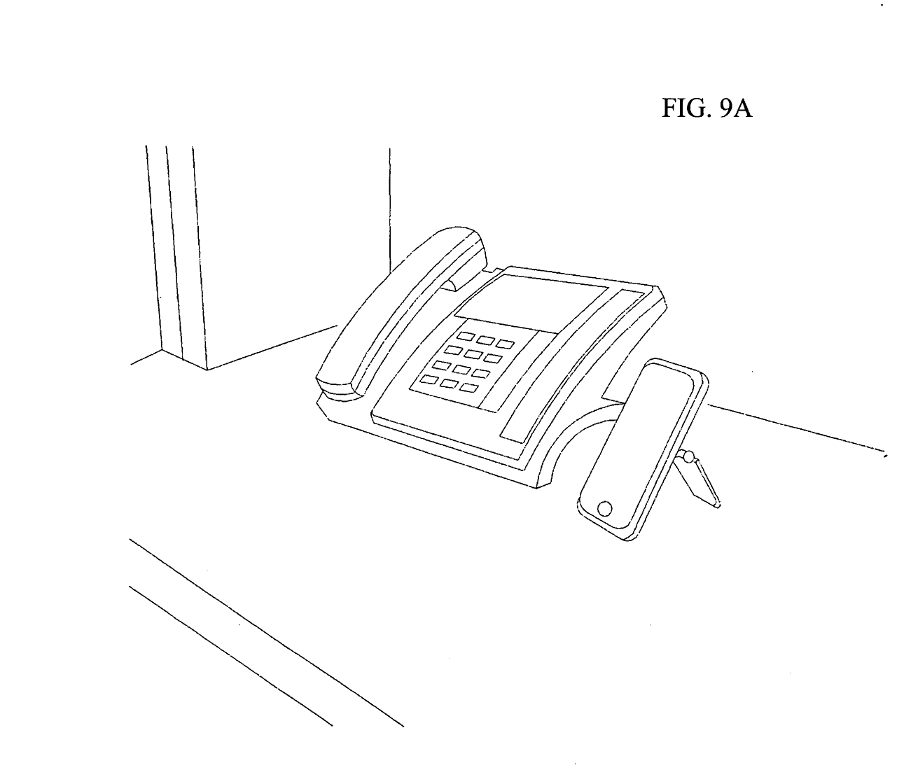

FIG. 6 shows apparatus 10 releaseably connected to a portable electronic device and angled sufficiently to maintain the apparatus in an upright position. FIGS. 7 and 8 show different views of the apparatus 10 connected to another portable electronic device and engaged with a dashboard seam located in a vehicle. FIGS. 9A shows apparatus 10 engaged with a portable electronic device in a vertical upright position located on a flat desk surface. FIG. 9B shows apparatus 10 engaged with a portable electronic device in a horizontal upright position located on a flat desk surface.

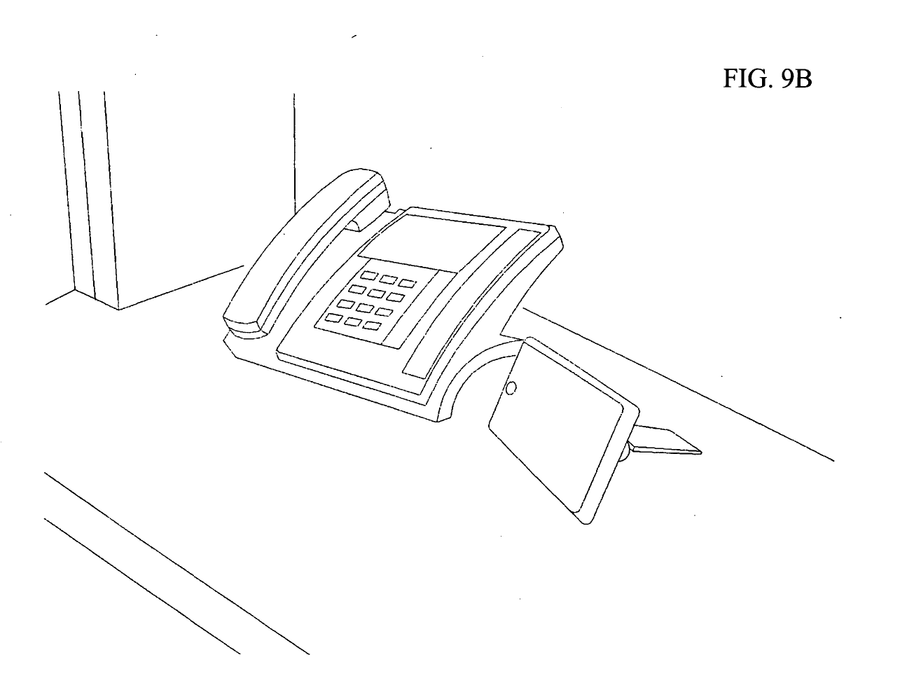

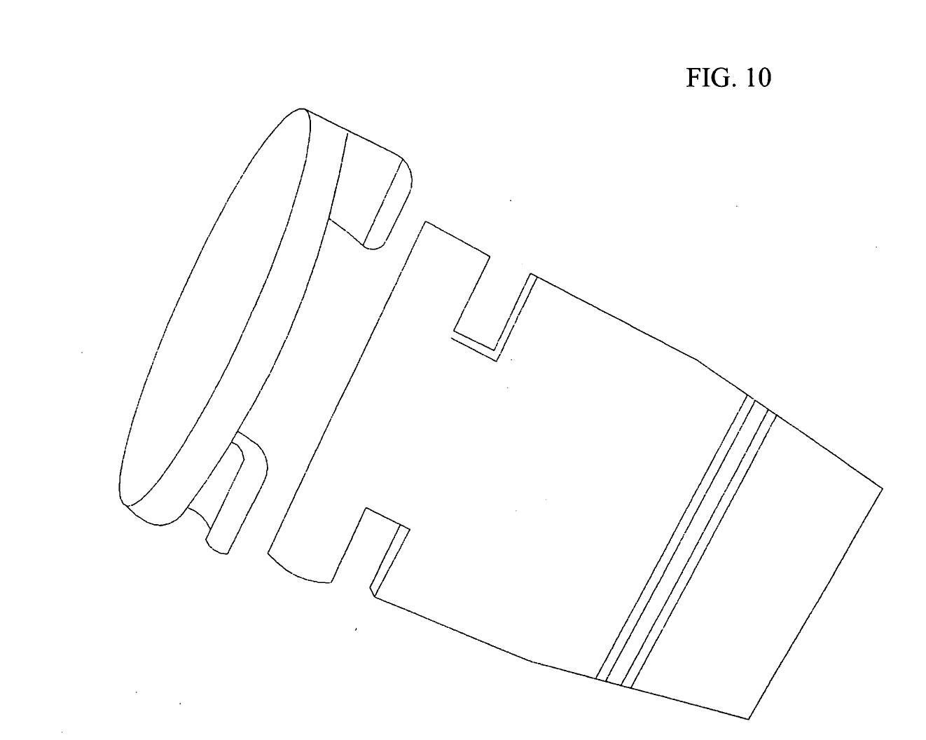

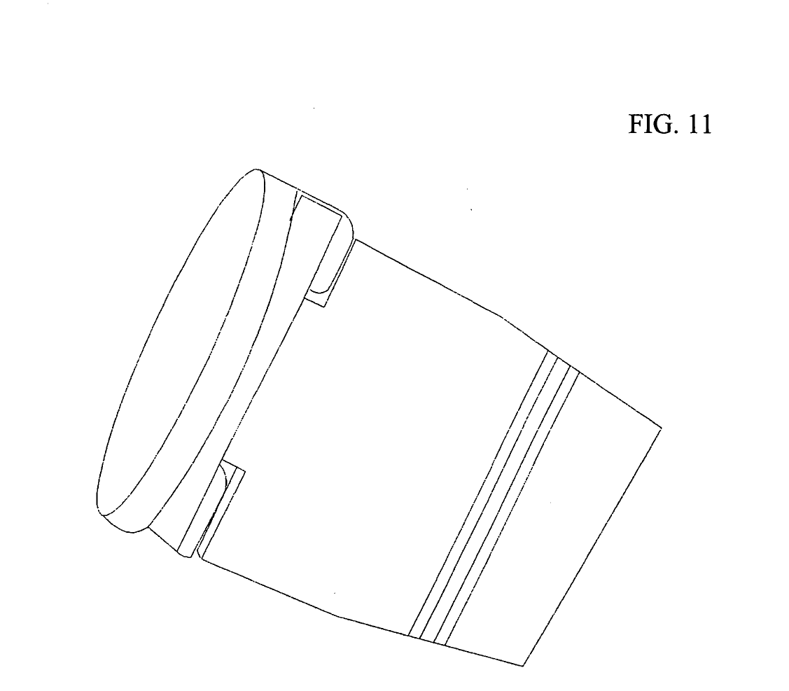

FIG. 10 shows a perspective and exploded view of the apparatus 10 with mounting portion 5 detached from base portion 1. FIG. 11 shows a perspective and exploded view of the apparatus 10 with mounting portion 5 attached to base portion 1.

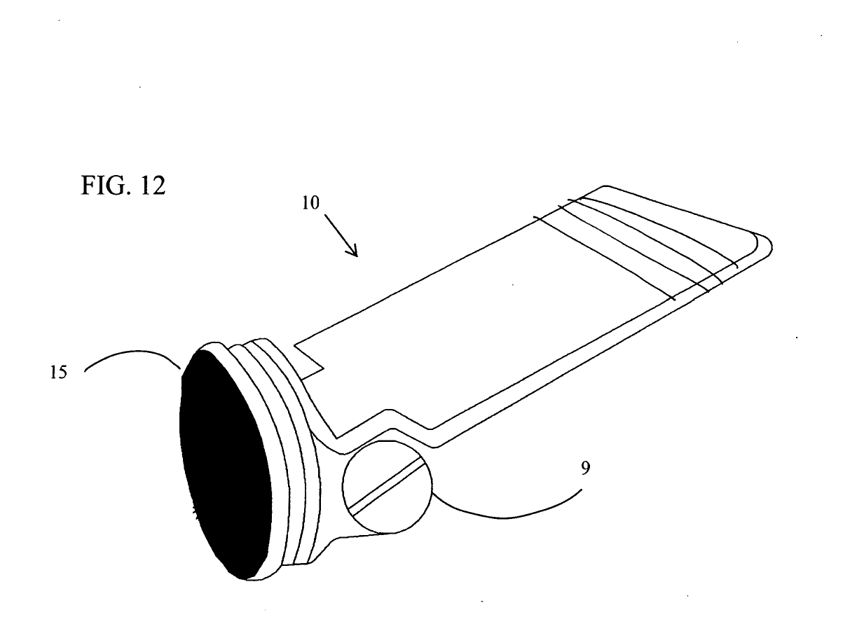

FIG. 12 shows an alternative embodiment of apparatus 10 in perspective view with mounting portion 5 attached to base portion 1 view pivot pin 9. Mounting portion 5 is shown with a magnetic fitting 15. Magnetic fitting 15 is designed to releaseably engage the back side of the portable electronic device having a ferrous material thereon.

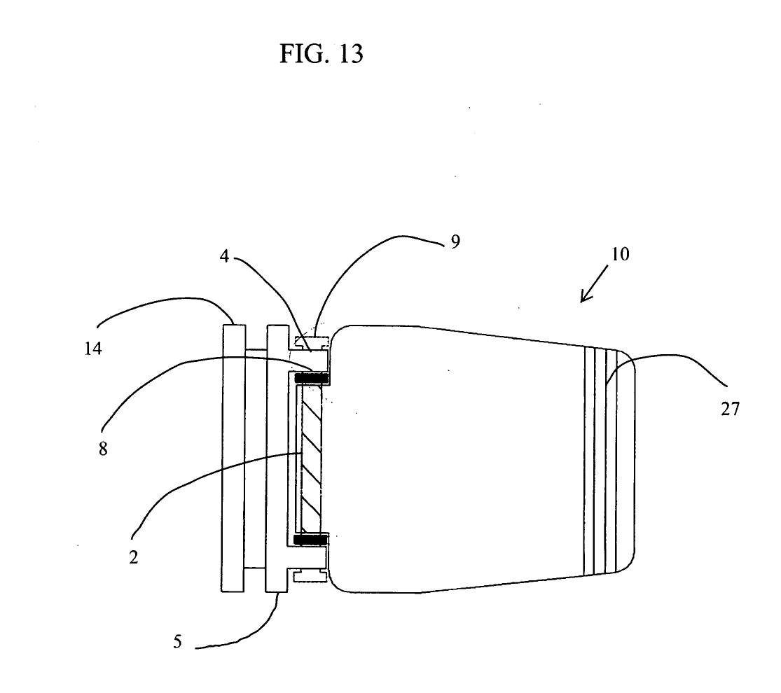

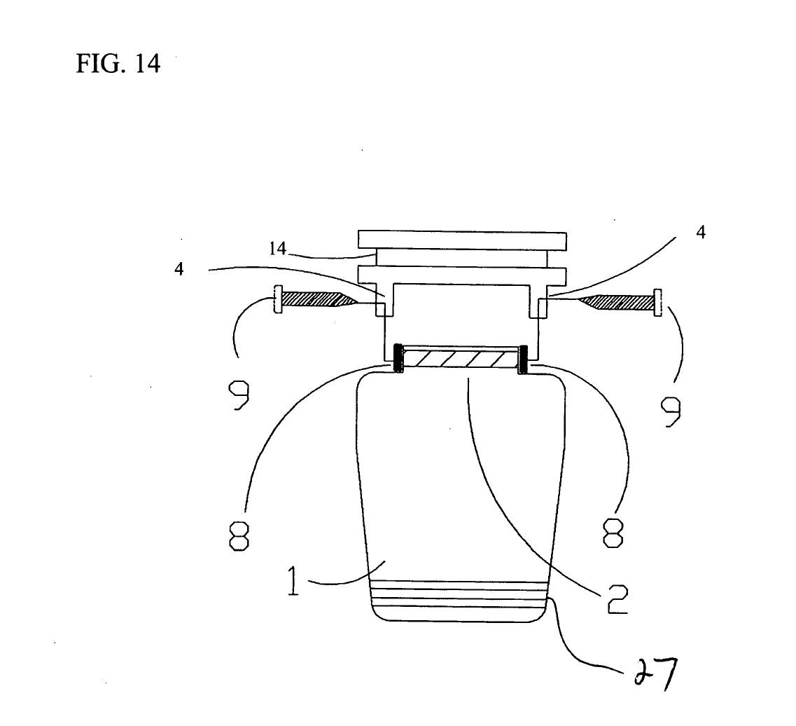

FIG. 13 shows a side view of apparatus 10 as shown in FIG. 12 in a rotated position with a interchangeable cap interface 14 connected to mounting portion 5. Base portion 1 also includes alternative ridges 27. This embodiment of the invention includes a mounting portion 5 having closed loop retention loops 4 that rotationally connected to base portion 1 via pins 9. Cantilevered beam portion 2 of base portion 1 alternatively includes pivot aperture 8 structured and arranged to receive pivot pins 9. Mounting portion 5 includes closed loop retention loops 4 having pin apertures designed to receive and pass therethrough pivots 9. FIG. 14 shows apparatus 10 according to FIG. 13 in an exploded view.

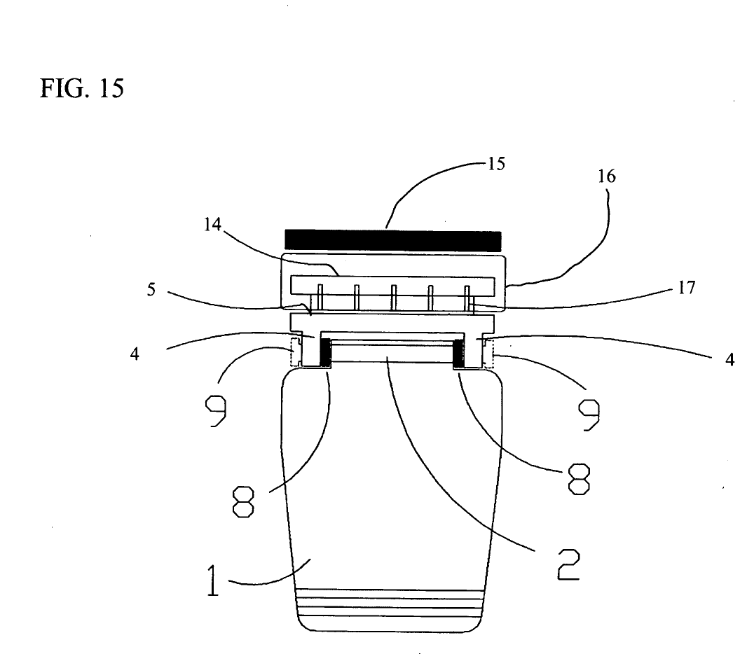

FIG. 15 shows another alternative embodiment of apparatus 10 with mounting portion 5 having a rotational cap 16 with magnetic fitting 15 affixed thereon. Rotational cap also include cap ridges 17 and in some embodiments the rotational cap is designed to releasable connect to a belt clip worn by a user (not shown).

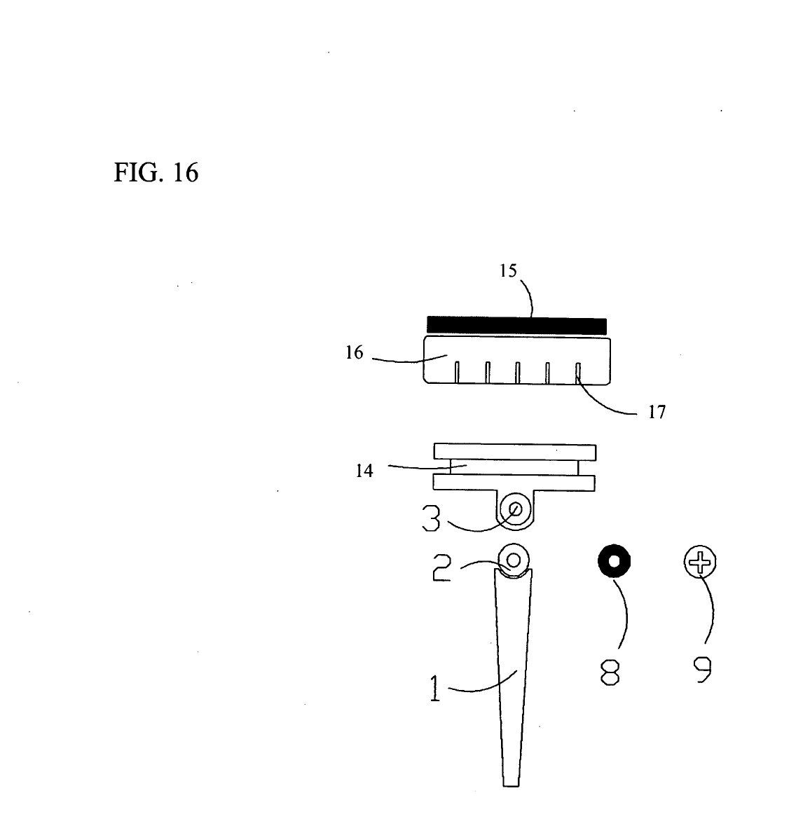

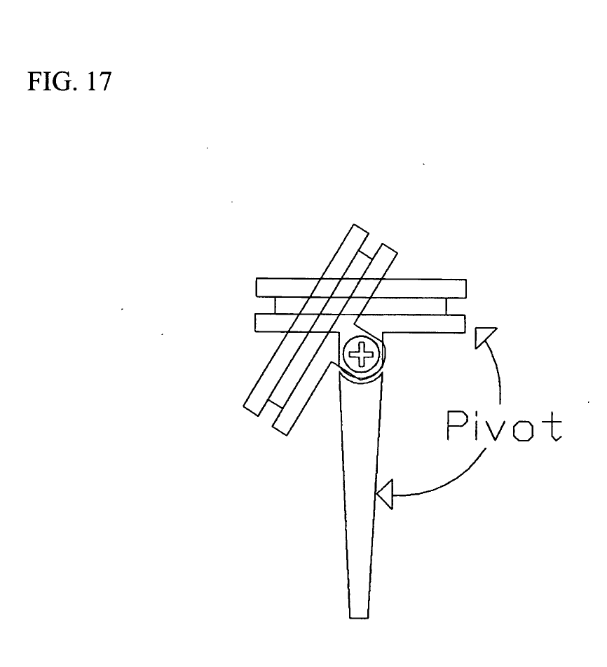

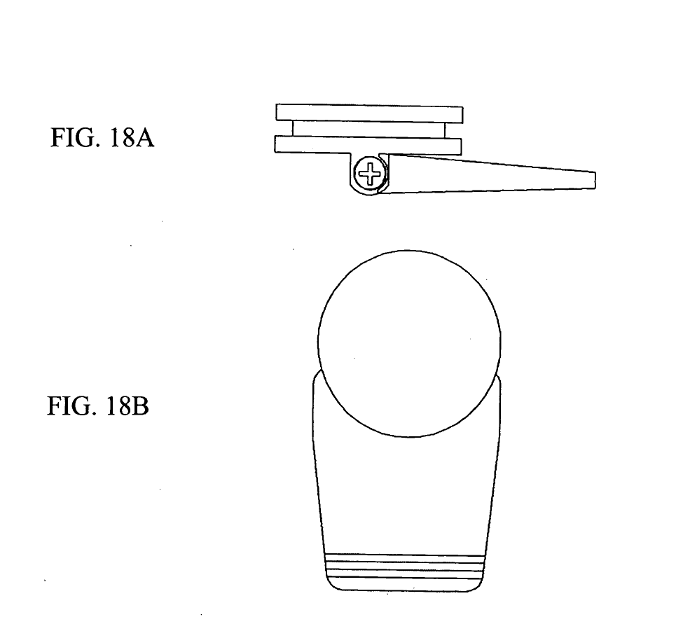

FIG. 16 shows a side and exploded view of the apparatus according to FIG. 15. FIG. 17 shows a side view of apparatus 10 according to FIG. 15 with mounting portion 5 in rotated position relative to base portion 1. FIGS. 18a and 18b show various views of apparatus 10 according to FIG. 15 from a forward position with mounting portion 5 in a completely rotated position relative to base portion 1.

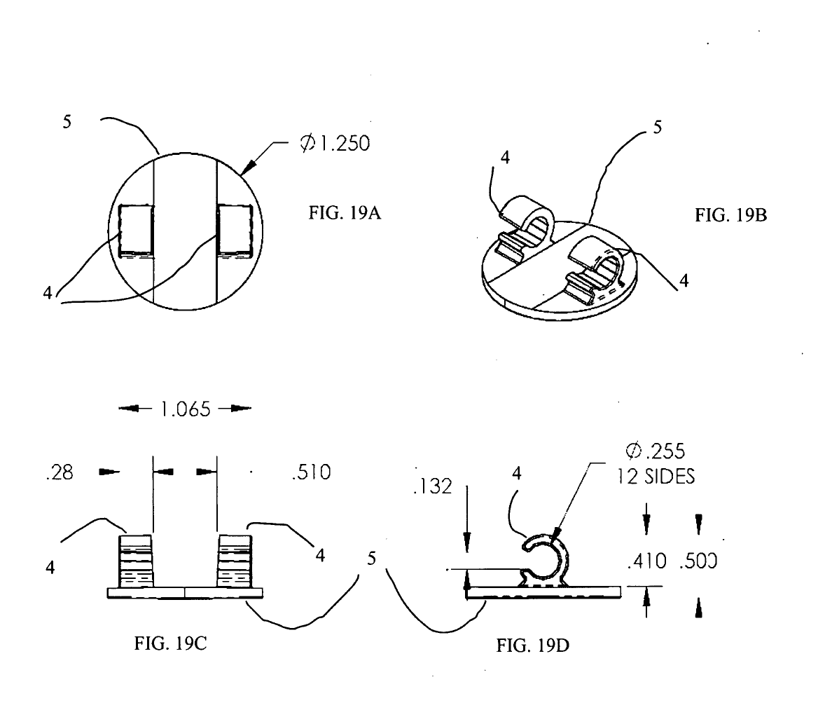

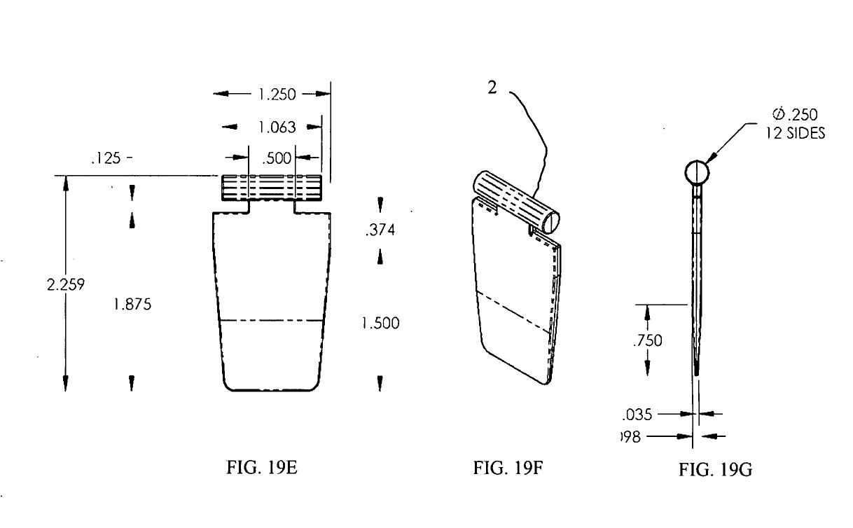

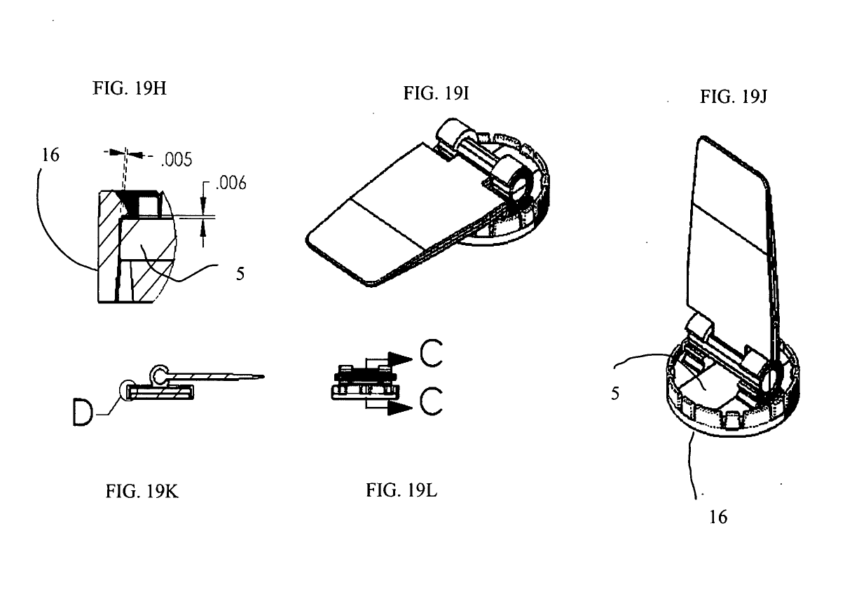

FIGS. 19A through 19L shows various exploded views of apparatus 10. FIG. 19B shows mounting portion 5 inverted to view retention loops 4. As can be seen loops 4 have a grooved interior surface. When mated with cantilevered beam portions 2 the grooved surfaces act to allow spaced shift rotations at specific angular amounts. For example, in FIG. 19D loops 4 are shown with 12 sides, each having a length of about 0.255. As such when base portion 1 is mated with mounting portion 5 base portion 1 can be rotated in 12 specific positions. It is understood that other dimensions of the loop 4 interior will suffice as long as a sufficient releasable snap-fit connection is attained between base portion 1 and mounting portion 5.

FIGS. 19E-19G shows base portion 1 with cantilevered beam portion 1 having a 12 sided shape to be mated with retention loops 4 as shown in FIGS. 19B and 19D.

FIGS. 19H-19L shows perspective and enlarged views of apparatus 10. Specifically FIG. 19K shows a side cut out view of apparatus 10 along cut-line C-C as shown in FIG. 19L. FIG. 19H shows exemplary dimensions of a rotational cap 16 fitted onto mounting portion 5.

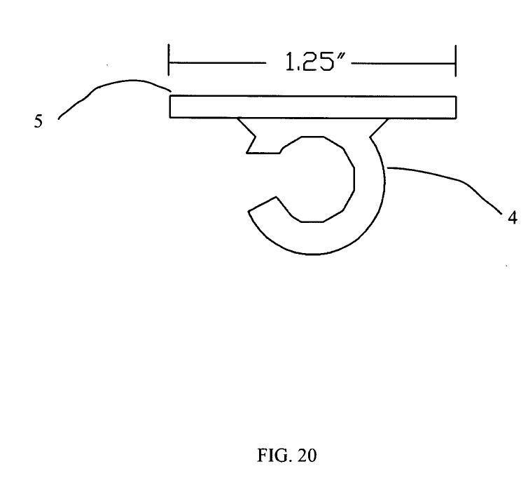

FIG. 20 shows an enlarged view of mounting portion 5 with retention loop 4 having a 12 sided interior for receiving a 12 sided cantilevered beam portion 2 of base portion 1. Mounting portion 5 is further shown with an exemplary size of 1.25 inches.

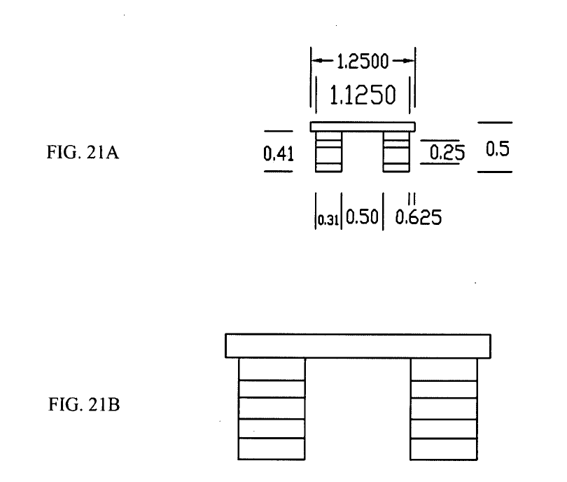

FIGS. 21A-21B show a side and cut-away view of mounting portion 5 specifically sowing the interior of retention loops 4 having exemplary dimensions.

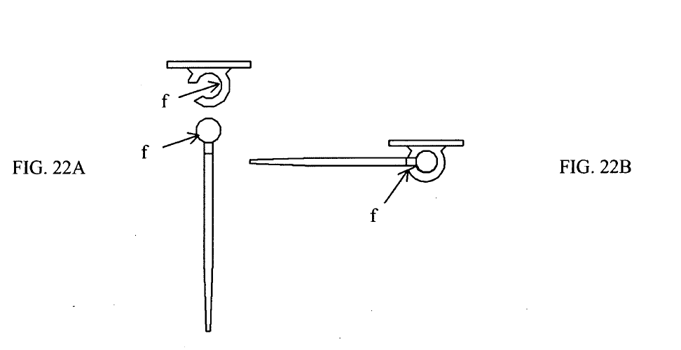

FIGS. 22A-22B show apparatus 10 in a disassembled and assembled view where cantilevered beam portion 2 of base portion 1 is designed to snap-fit into loops 4 of mounting portion 5 along line f.

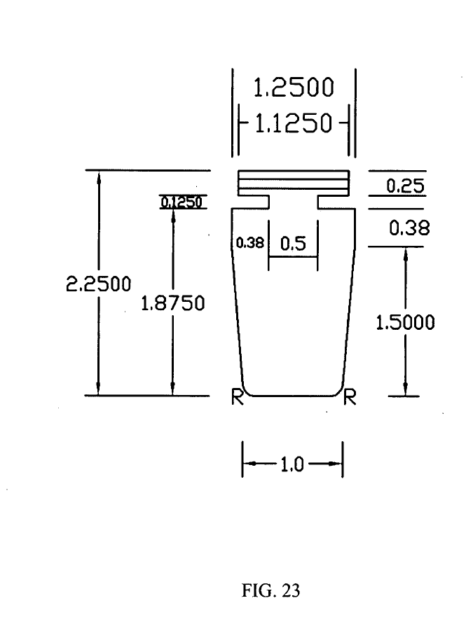

FIG. 23 shows base portion 1 with cantilevered beam portion 2 having exemplary sizes and dimensions.

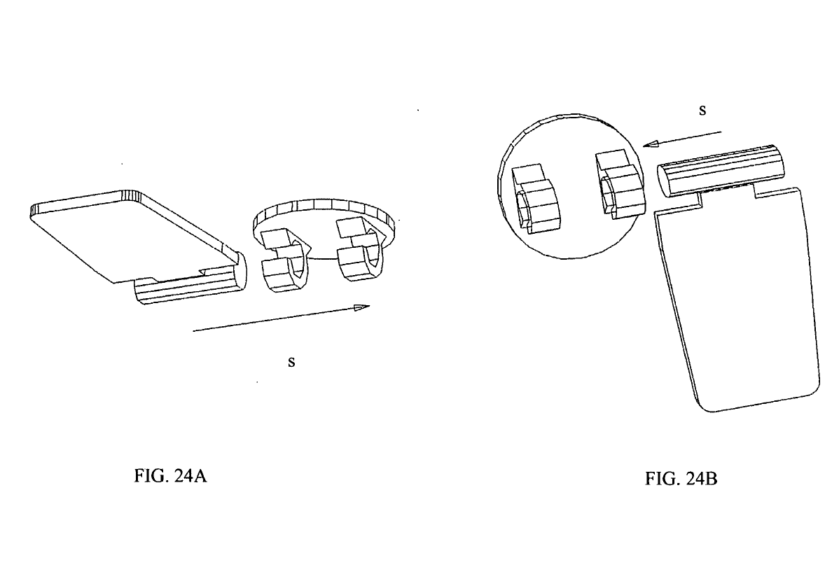

FIGS. 25A-24B show perspective views of apparatus 10 being assembled in an alternative fashion. Cantilevered beam portion 2 is slid in the direction of line s and engages retention loops 4 along the edges of the interior of loops 4. In this embodiment cantilevered beam portion 2 is preferable the same shape and dimensions as the interior of retention loops 4.

Friction engaging ridges 6 and 27 are designed to frictionally engage any tight fitting seam, for example, such as the seams in a car dashboard as shown in FIGS. 7 and 8. The ridges are designed to securely fasten apparatus 10 along with a portable electronic device to a dashboard seam in such a position so that the user may operate the vehicle and safely view the business end of the electronic device without holding it. The number of ridges can be as shown, specifically four ridges. However any number of ridges can be used for suitable affixing into a seam. Additionally the dimensions of the ridges can vary from triangular to square to round depending upon the specific seam required. Critical to the invention is that the ridges frictionally engage a seam with the ability to be removed without damaging the surface of the seam joint.

In addition, base portion 1 may also be inserted into a seam in any location within the viewing area of a user, such as for example, the seam of a tray table in an upright and locked position on the back of an airplane seat. The rotational aspect of mounting portion 5 relative to base portion 1 allows the user to affix the apparatus into any suitable seam and still allow unobstructed hands free viewing of the business end of a portable electronic device.

The apparatus is preferably made from a flexible yet strong material in order to adequately secure portable devices many times the weight of the apparatus itself. Suitable materials can include polymers plastics, rubber, metal and wood. Critical to the preferred embodiment is the fact that the apparatus is lightweight yet sturdy. To this end, any suitable material will suffice.

It will be apparent to one of skill in the art that described herein is a novel universal portable device stand and holder apparatus. While the invention has been described with reference to specific preferred embodiments, it is not limited to these embodiments. The invention may be modified or varied in many ways and such modifications and variations as would be obvious to one of skill in the art are within the scope and spirit of the invention and are included within the scope of the following claims.

1. An apparatus for supporting a portable device, the apparatus comprising, an elongated base portion having a wedge end and a pivot end;
a mounting portion, the mounting portion rotationally and pivotally connected to the base portion at the pivot end, the mounting portion for releasably engaging the portable device;
the mounting portion including a mounting cap structured and arranged to releasably engage the portable device; and
the base portion having at least one ridge located substantially proximal to the wedge end and being substantially parallel to the pivot end, the at least one ridge including an elevated forward facing surface and an elevated rearward facing surface for frictionally engaging an orifice of a support structure in order to support the device and an engaged portable device in a desired position.

2. The apparatus according to claim 1 further comprising a snap and fit connection, the snap and fit connection for connecting the mounting portion to the pivot end of the base portion.

3. The apparatus according to claim 1 further comprising a pin connection, the pin connection for connecting the mounting portion to the pivot end of the base portion.

4. The apparatus according to claim 1, the base portion having a tapered shape such that the pivot end has a larger width than the wedge end.

5. The apparatus according to claim 4, the base portion having wedge shape such that the pivot end has a large depth than the wedge end.

6. The apparatus according to claim 1, the mounting portion including a magnetic portion for engaging the portable device.

7. The apparatus according to claim 1, the mounting portion including a hook and loop combination for engaging the portable device.

8. The apparatus according to claim 1, where the mounting portion engages the base portion with a releasable slide and groove combination.
